(19) United States
(12) Patent Application Publication
(10) Pub. No.: US 2011/0221296 A1
(43) Pub. Date: Sep. 15, 2011

(54) Internal Rotor Including a Grooved Shaft Intended for a Rotary Electric Machine

(75) Inventor: Bertrand Vedy, La Tour de Peliz (CH)

(73) Assignees: SOCIETE DE TECHNOLOGIE MICHELIN, Clermont-Ferrand (FR); Michelin Recherche et Technioque S.A., Granges-Paccot (CH)

(21) Appl. No.: 13/059,591

(22) PCT Filed: Jul. 28, 2009
(86) PCT No.: PCT/EP2009/005454

§ 371 Date: May 9, 2011

(30) Foreign Application Priority Data
Aug. 20, 2008 (FR) 0855631

(51) Int. Cl. H02K 1/28

(52) U.S. Cl. 310/156.14

(57) ABSTRACT

A buried-magnet internal rotor (1) for an electric rotating machine, the rotor comprising: a shaft (2), a plurality of polar parts (30) made of a magnetic material and surrounding the shaft, the polar parts delimiting housings (40) between them, and a plurality of permanent magnets (4) placed in the housings (40), wherein the shaft comprises a plurality of longitudinal splines (21) interacting with radial tenons of the polar parts.

The invention relates to electric rotating machines in which the rotor comprises permanent magnets. More precisely, the invention relates to machines in which the magnets are placed in recesses of the rotor. The electric machines in question are commonly designated by the expression “buried-magnet”. This arrangement principle of the rotor is widely applied to self-controlled flux density synchronous machines.

The size of an electric rotating machine depends on its nominal torque. The higher the torque that a motor is capable of delivering, the bigger the electric motor, all other things being equal. There are however applications for which it is desirable to achieve at the same time considerable powers and a large degree of compactness of the motor. Simply to give a practical example, when it is desired to implant electric traction motors in the wheels of motor vehicles, it is desirable to be able to develop powers of at least 10 kW per motor, and even most of the time at least 25 or 30 kW per motor, for the lowest possible weight in order to limit as much as possible the unsuspended weights. It is also desirable that the space requirement is extremely small, exceeding by as little as possible the internal volume of the wheel so as not to interfere with the elements of the vehicle during travels of suspension and during other types of movement of the wheel relative to the body shell of the vehicle.

These two imperatives (high power, low space requirement and weight) make it very problematical to install electric traction motors in the wheels of passenger vehicles without radically improving the weight/power ratio of the electric machines currently available on the market.

Choosing a high speed for an electric motor when the motor is designed is a solution making it possible, for a given power, to reduce the torque and hence the space requirement. In other words, for a given nominal power of the motor, the higher its nominal rotation speed, the smaller its space requirement will be.

Raising the rotation speed of an electric rotating machine on the other hand poses many problems, notably with respect to the centrifugal forces sustained by the elements of the rotor, in particular the magnets and the polar parts.

Another difficulty encountered in the design of such motors is associated with the magnitude of the motive forces that are generated within the magnets and that must be transmitted to the motor shaft.

The (mechanical and acoustic) vibrations are also a difficulty that increases as the rotation speed increases.

A specific design for achieving high rotation speeds has already been proposed in patent application EP 1001507. The speeds proposed in this patent application are of the order of 12 000 rpm, by proposing for this a particular arrangement of the assembly consisting of a polygonal one-piece shaft and polar parts judiciously placed around this shaft.

An enhancement making it possible to aim at speeds of the order of 20 000 rpm has been proposed in patent application EP 1359657 by proposing for this an arrangement using wedges to radially lock the magnets in their housings.

One object of the invention is to propose an enhanced rotor, notably with respect to the transmission of the motive forces of the shaft.

The invention therefore relates to a buried-magnet internal rotor for an electric rotating machine, the rotor comprising:
a shaft,
a plurality of polar parts made of a magnetic material and surrounding the shaft, the polar parts delimiting housings between them,
a plurality of permanent magnets placed in the housings,
   the said rotor being characterized in that the shaft comprises a plurality of longitudinal splines interacting with radial tenons of the polar parts.

Preferably, the shaft comprises as many longitudinal splines as the rotor has poles.

Preferably, the rotor being a hexapolar rotor, the shaft comprises 6 longitudinal splines.

Also preferably, the radial walls of each longitudinal spline of the shaft are parallel to one another.

Preferably, the polar parts consist of a stack of metal sheets, each metal sheet extending substantially radially from the shaft and comprising a radial projection, the said radial projection forming a portion of the said tenon.

Preferably, the rotor also comprises a lateral shroud axially on either side of the polar parts along the shaft, the said lateral shrouds axially clamping the polar parts by means of tie-rods, the centrifugal forces exerted on the polar parts being absorbed by the said lateral shrouds.

Also preferably, the central opening of one of the lateral shrouds comprises a shoulder capable of interacting with an internal shoulder of the shaft in order to define an axial position of the polar parts on the shaft.

Also preferably, the lateral shrouds are mounted slidingly in rotation on the shaft.

The invention also relates to an electric rotating machine comprising such a buried-magnet rotor.

The invention will be better understood by virtue of the rest of the description which is based on the following figures:

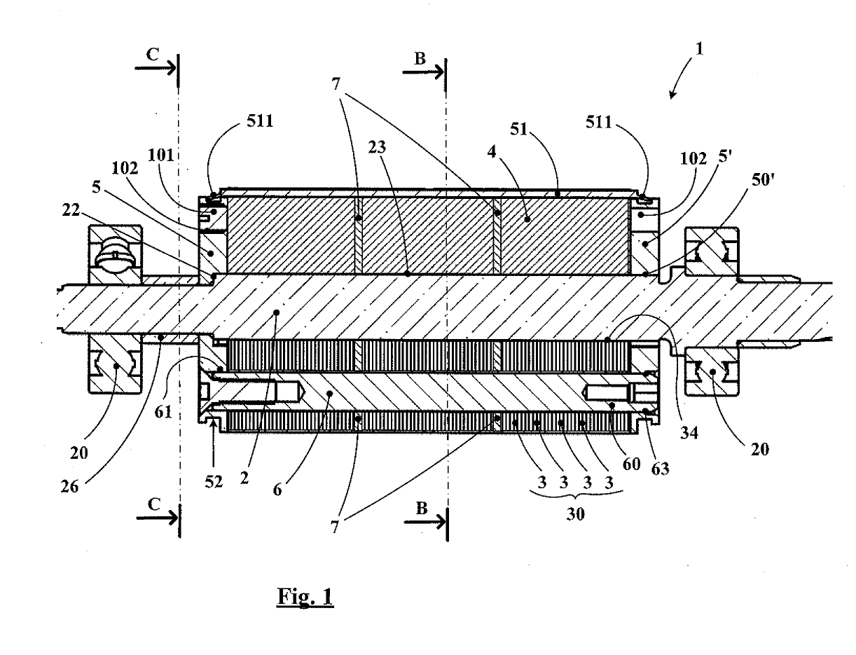

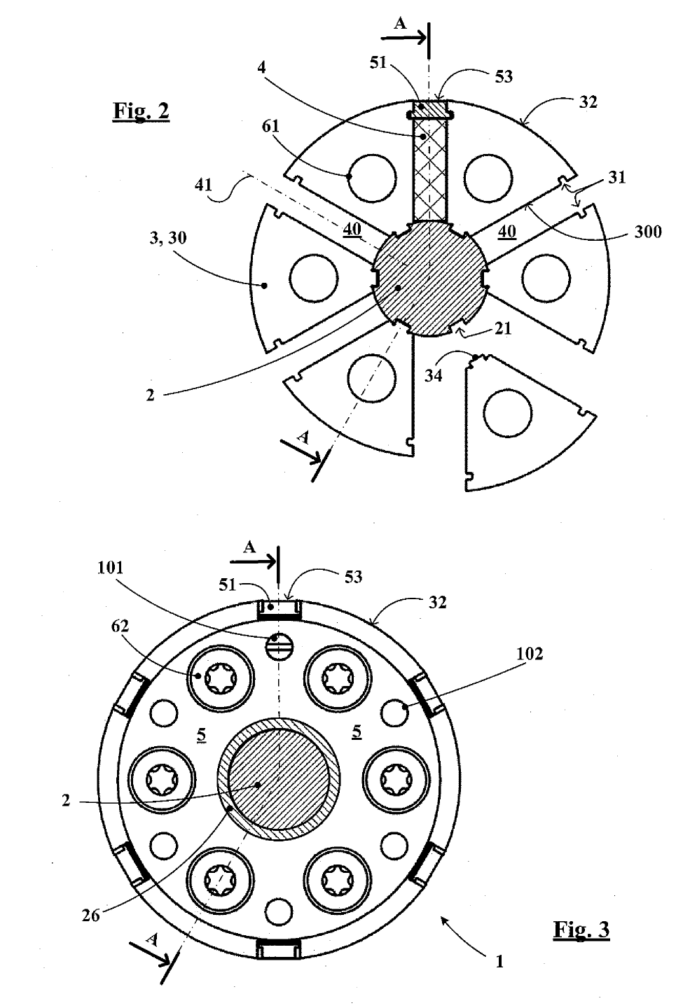

FIG. 1 is a view in section along the axis of a rotor according to the invention following a dashed line A-A that can be seen in FIGS. 2 and 3.

FIG. 2 is a partial view in section perpendicular to the axis of the rotor of FIG. 1 following a line B-B that can be seen in FIG. 1.

FIG. 3 is a view in section perpendicular to the axis of the rotor of FIG. 1 following a line C-C that can be seen in FIG. 1.

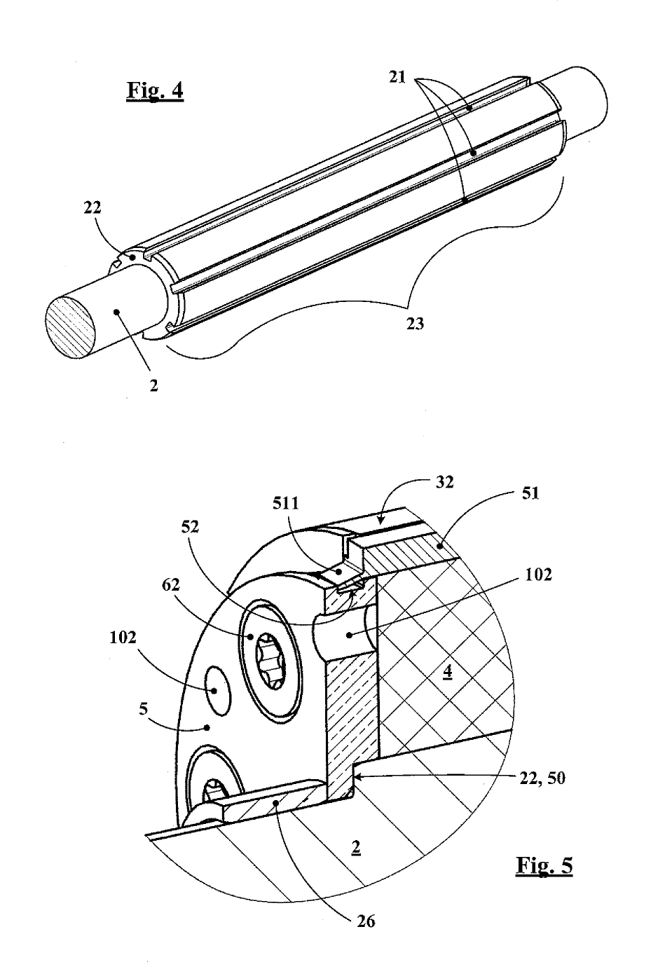

FIG. 4 is a view in perspective of the shaft 2.

FIG. 5 is a view in perspective of a section along the axis of the rotor of the detailed embodiment of the shrouds and of the magnet wedges.

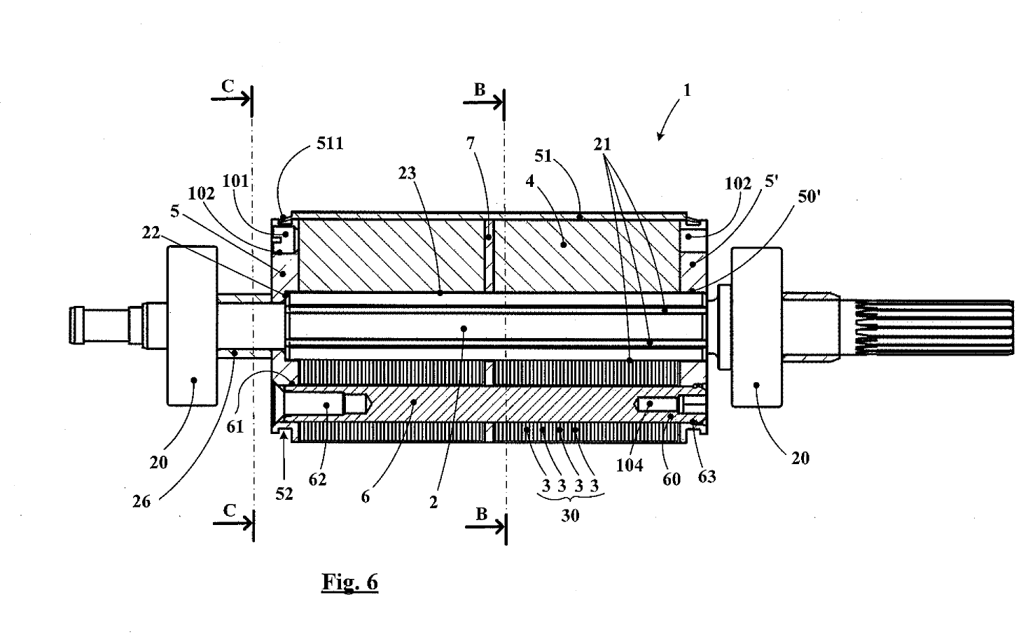

FIG. 6 is a view similar to FIG. 1 of a second embodiment of the rotor according to the invention.

The appended figures show a rotor 1 for a hexapolar machine also comprising a stator that is not shown. The rotor 1 comprises a one-piece shaft 2 resting on bearings 20. Six polar parts 30 can be seen, preferably formed by a stack of ferromagnetic metal sheets 3. Each metal sheet 3 is substantially perpendicular to the axis of the shaft. The metal sheets may be extremely thin, for example of the order of a few tenths of a millimetre, for example 0.2 mm. Note simply in passing that the invention is also useful in the case of solid polar parts (not-layered).

Axially on either side of the shaft 2, a lateral shroud 5, 5′ (preferably made of a non-magnetic material) can be seen situated on each side of the polar parts 30. FIG. 1 also shows two optional intermediate shrouds 7 (preferably also made of a non-magnetic material). Each lateral shroud and as appropriate each intermediate shroud 7 comprises a central opening. In the non-limiting example described in FIG. 1, the shape of the central opening of the lateral shrouds is circular while that of the central opening of the intermediate shrouds is adjusted to that of the shaft 2, that is to say in this instance splined.

For each of the polar parts 30, a tie-rod 6 passes through the stack of metal sheets 3, as appropriate the intermediate shroud(s), and makes it possible to clamp the assembly between the lateral shrouds 5 and 5′. The centrifugal forces sustained by the polar parts are therefore absorbed by the lateral shrouds and, as appropriate, by the intermediate shrouds to the exclusion of any other means.

The shaft 2 also comprises, in this instance, an internal shoulder 22 designed to interact with a first lateral shroud 5 in order to determine its axial position and therefore the axial position of the polar parts on the shaft (see in particular FIGS. 1, 4, 5 and 6). The shoulder 22 of the shaft preferably rests at the bottom of a facing 50 of the shroud. An external ring 26 secured to the shaft for example by shrink-fitting immobilizes the shroud by pressing it axially against the shoulder of the shaft. The second shroud, which can be qualified as “floating”, does not therefore rest on a shoulder of the shaft, but remains free to move axially as dictated by the thermal expansions of the stack. This floating shroud may comprise a facing substantially identical to that of the immobilized shroud or, on the contrary, be bored throughout its thickness as shown here (see bore 50′ of the second shroud).

Parallelepipedal permanent magnets 4 are shown placed in the housings 40 between the polar parts 30. The housings are interrupted by the intermediate shroud(s) 7. In the example of FIG. 1, there are therefore 3 magnets per pole whereas in the example of FIG. 6, there are only 2 magnets per pole. Each of the housings of the magnets is closed by a magnet wedge 51.

Moreover, as can be seen in FIG. 2, the longitudinal faces 300 of the polar parts 30 each comprise a spline 31 parallel to the axis of the rotor, hollowed out to a radial level close to the external edge 32 of each polar part 30 (and therefore of each metal sheet 3), the said polar parts moreover having a height (or more exactly a radial dimension) slightly greater than the height of the magnets 4. Each wedge 51 therefore rests on two splines 31 placed on each of the adjacent polar parts. The magnets 4 are therefore mechanically secured to the polar parts 30. The essential function of each spline 31 is to form a shoulder in order to oppose the centrifugation of the wedges and of the magnets. The polar parts are themselves secured together by virtue of the tie-rods and the lateral shrouds and if necessary the intermediate shroud(s).

The wedges 51 are T-shaped. The “T” is upside down when looking at a wedge placed at the top of the rotor (FIG. 2). The flanges of the “T” and the splines 31 have flat radial bearing surfaces, that is to say surfaces that are perpendicular to the central radius 41 of the housing 40. This profile of the wedges 51 and of the splines 31 on the one hand allows the rotor to withstand the centrifugation without, on this occasion, generating any force tending to widen the housings 40.

The radial portion (the foot) of the “T” on the other hand fills the space between the polar parts which gives the rotor a practically smooth external surface (even in the absence of grinding) because the radially external surface 53 of the wedge is flush with the external surface 32 of the polar parts.

The top of the wedge 53 may even be slightly domed (preferably adopting the same radius as the outside of the rotor) in order to exactly extend the curvature of the external edge 32 of the metal sheets. In this manner, the high-speed rotation again causes fewer acoustic vibrations (noise). Moreover, the corners of the splines and of the wedges are rounded at a radius of approximately 0.5 mm in order to prevent concentrations of stresses.

The T-shaped profiles shown here are preferred profiles but other profiles known per se, such as simple flat (rectangular) profiles, can be used in the context of the present invention.

As detailed in FIG. 5, the ends 511 of the wedges 51 extend axially on either side beyond the polar parts in recesses 55 of the lateral shrouds. Preferably, the ends 511 are made thinner so as to be able to be bent over in a peripheral groove 52 of the lateral shrouds in order to be axially immobilized therein. This arrangement has also been found to be advantageous in the matter of acoustic vibrations (noise) when the motor is rotating at high speed. To allow them to be folded over into the peripheral groove 52, the ends 511 of the wedges are preferably made thinner while not including the radial portion of the T-shaped profile. The ends 511 are then in the form of tongues. Again preferably, the external wall of the peripheral grooves 52 is inclined relative to the axial direction at an angle substantially less than 90°, for example of the order of 70°, in order to create an axial clamping of the wedges when they are bent over.

According to the invention, the polar parts 30 comprise a tenon designed to interact with a spline 21 of the shaft 2. It is this connection that directly transmits the torque from the polar parts to the shaft. The splines 21 preferably have parallel walls and interact with tenons with bearing faces that are also parallel. Since the polar parts are preferably formed of a stack of ferromagnetic metal sheets 3, each metal sheet comprises a substantially rectangular radial projection 34 which forms a portion of the tenon. Naturally, if only one portion of the metal sheets of a polar part comprises this projection, the stresses will be concentrated on those metal sheets.

FIGS. 2 and 4 show that the shaft preferably comprises as many splines as poles (in this instance six in number) but it can be understood that, depending on the forces involved, it would be possible to restrict oneself to only 4, 3 or even 2 splines.

The shoulder(s) 22 preferably correspond(s) to the ends of the central splined portion 23 of the shaft. Because of the presence of the facing 50 and of the bore 50′, these ends are then retracted into the shrouds 5 and 5′. In this manner, the end metal sheets of the stacks cannot escape from the splined central portion 23 of the shaft. This is particularly advantageous during the assembly of the rotor.

Weights can also be attached to the shrouds in order to perfect the static and dynamic balance of the rotor.

According to the embodiment of the invention of FIGS. 1, 3 and 6, the balance weights have the shape of a headless screw 101 which is positioned in threaded drill holes 102 in the shrouds. Preferably, the drill holes are situated as here facing the magnets 4 so that the balance screws can axially clamp the magnets. Each shroud therefore comprises six threaded drill holes 102 in addition to the six passageways 61 for the six tie-rods 6.

According to a second embodiment, the balance weights may be positioned in indentations 104 in the ends 60 of the tie-rods. The weights may, for example, take the form of headless screws to match the threads made in the indentations of the tie-rods or even in the heads of the tie-rod screws 62.

It can be understood that by varying the position, the length and/or the material chosen for each balance weight, it is possible to adjust the balance of the rotor. Since the number of threads is limited, it is often necessary to combine the effect of two weights, each positioned in a specific drill hole in order to obtain a sufficiently fine balance. To obtain a satisfactory dynamic balance, it is often useful to place weights on each of the two lateral shrouds.

Preferably, the weights are also immobilized by bonding in their threads in order to ensure that they are held in their axial position.

The figures also show specific tie-rods 6 and tie-rod screws 62. The heads of the tie-rods are sunk into one of the shrouds (in this instance on the right of the figure) and are simply stopped by a retaining ring 63 interacting with a shoulder 64 of the shroud. The tie-rod screws 62 are screws of which the countersunk heads are sunk into the thickness of the shroud (on the left in the figure).

This design makes it possible on the one hand to reduce the axial space requirement of the rotor and on the other hand to obtain shrouds that are practically smooth and therefore generate little noise.

The central opening of the intermediate shroud 7 of the rotor of FIG. 6 is circular, that is to say that it does not make it possible to transmit rotary force to the shaft. In this example, the whole of the torque is therefore transmitted to the shaft by the projections 34 of the metal sheets since all the shrouds (lateral and intermediate) are mounted slidingly in rotation on the shaft. The configuration shown in FIG. 1, in which the intermediate shrouds also comprise tenons, can, on the other hand, be chosen to make it even easier to transmit the torque and even easier to align the passageway 61 for the tie-rods when the rotor is assembled.

The rotor withstands without damage very high rotation speeds, much higher than 10 000 rpm, namely speeds of the order of 20 000 rpm at least.

The figures show a hexapolar rotor, that is to say comprising 3 pairs of poles, but those skilled in the art can transpose the technical disclosures of the present application to rotors comprising for example 2, 4 or 5 pairs of poles instead of three.

1. A buried-magnet internal rotor for an electric rotating machine, the rotor comprising:
a shaft;
a plurality of polar parts made of a magnetic material and surrounding the shaft, the polar parts delimiting housings between them; and
a plurality of permanent magnets placed in the housings;
wherein the shaft comprises a plurality of longitudinal splines interacting with radial tenons of the polar parts.

2. The rotor according to claim 1, wherein the shaft comprises as many longitudinal splines as the rotor has poles.

3. The rotor according to claim 2, the rotor being a hexapolar rotor, the shaft comprising 6 longitudinal splines.

4. The rotor according to claim 2 wherein, the radial walls of each longitudinal spline of the shaft are parallel to one another.

5. The rotor according to claim 1, wherein the polar parts consist of a stack of metal sheets, each metal sheet extending substantially radially from the shaft and comprising a radial projection, said radial projection forming a portion of said tenon.

6. The rotor according to claim 1, further comprising a lateral shroud axially on either side of the polar parts along the shaft, said lateral shrouds axially clamping the polar parts with tie-rods, the centrifugal forces exerted on the polar parts being absorbed by said lateral shrouds.

7. The rotor according to claim 6, wherein the central opening of one of the lateral shrouds (5) comprises a shoulder capable of interacting with an internal shoulder of the shaft in order to define an axial position of the polar parts on the shaft.

8. The rotor according to claim 7, wherein the lateral shrouds are mounted slidingly in rotation on the shaft.

9. An electric rotating machine comprising a buried-magnet rotor according to claim 1.
